(19) United States
(12) Patent Application Publication
(10) Pub. No.: US 2013/0111516 A1
(43) Pub. Date: May 2, 2013

(54) APPARATUS AND METHOD FOR PROVIDING A CUSTOMIZED INTERFACE

(71) Applicants: Eui-Seung SON, Incheon (KR); Joo-Hee KIM, Daejeon (KR); Won-Yeol LEE, Seoul (KR); Eun-Kyoung PAIK, Seongnam-si (KR); Hyun-Pyo KIM, Seoul (KR)

(72) Inventors: Eui-Seung SON, Incheon (KR); Joo-Hee KIM, Daejeon (KR); Won-Yeol LEE, Seoul (KR); Eun-Kyoung PAIK, Seongnam-si (KR); Hyun-Pyo KIM, Seoul (KR)

(73) Assignee: KT CORPORATION, Seongnam-city (KR)

(21) Appl. No.: 13/614,776

(22) Filed: Sep. 13, 2012

(30) Foreign Application Priority Data
Nov. 1, 2011 (KR) 10-2011-0112890

(51) Int. Cl. H04N 21/482

(52) U.S. Cl. 725/25

(57) ABSTRACT

An apparatus for providing an interface customized to contents among a plurality of contents is disclosed. The apparatus includes a contents provider configured to receive, from a first device, user information of the first device and a content request signal that requests the contents among the plurality of contents, and provide the requested contents to the first device based on the received user information of the first device, an interface request receiver configured to receive, from a second device, user information of the second device and an interface request signal that requests interface data, and an interface data provider configured to authenticate the second device by using both the user information of the first device and the user information of the second device, and provide interface data corresponding to the provided contents to the second device if the second device is authenticated.

### CROSS-REFERENCE TO RELATED APPLICATION

This application claims priority from Korean Patent Application No. 10-2011-0112890, filed on Nov. 1, 2011 in the Korean Intellectual Property Office, the entire disclosure of which is incorporated herein by reference.

### BACKGROUND

1. Field

Apparatuses and methods consistent with exemplary embodiments relate to an apparatus and method for providing an interface customized to contents.

2. Description of the Related Art

Recently, with the advent of smart phones having touch screens, users can install and use various applications in their phones. Further, there is provided an environment where the users can access the internet at anytime and anywhere, thus allowing the users to use services optimized for their needs. Furthermore, there is also provided an environment where a user interface optimized for each application and a web service can be configured, thus allowing the users to use smart phone-based services easily and conveniently.

Moreover, recently, with the distribution of super high-speed communication networks and the convergence of broadcasting and communication technologies, internet protocol television (IPTV) capable of receiving desired contents selectively through a super high-speed communication network has become a major part of the broadcasting and communication industry. As compared to a conventional broadcasting system in which viewers just passively watch contents transmitted from a broadcasting station, the viewers can watch IPTV at any desired time. Thus, the viewers' convenience and satisfaction can be dramatically improved. IPTV has been developed to provide broadcasting contents such as real-time broadcasting and Video on Demand (VOD), and various other supplementary services such as karaoke, Social Network Service (SNS), video phone calls and games.

With the existing IPTV services, however, since the various services provided by the IPTV, such as real-time broadcasting, VoD, karaoke, SNS, video phone calls and games, should be controlled with a single remote controller, the remote controller has a very complicated structure. Thus, it has been very difficult and inconvenient to use the remote controller.

Besides, an existing IPTV set top box is capable of processing only one control signal at one time. Thus, when several users want to use the service of the IPTV simultaneously, as in a game, the users cannot control the IPTV service simultaneously. Even if the IPTV set top box can process multiple signals at the same time, the users need to purchase additional remote controllers.

Meanwhile, Korean Patent Publication No. 2010-0015096 describes a “Set Top Box Control Device For Digital Broadcasting, An Operating Method Thereof and A Digital Broadcasting System,” which is related to a technology for supporting various types of input schemes with a touch pad while controlling a set top box.

### SUMMARY

Exemplary embodiments provide an apparatus and method capable of providing a user interface optimally customized to each of various types of contents to a user device.

According to an aspect of an exemplary embodiment, an apparatus for providing an interface customized to contents among a plurality of contents is provided. The apparatus may include a contents provider configured to receive, from a first device, first user information of the first device and a content request signal that requests the contents among the plurality of contents, and provide the requested contents to the first device based on the received first user information of the first device, an interface request receiver configured to receive, from a second device, second user information of the second device and an interface request signal that requests interface data, and an interface data provider configured to authenticate the second device by using the first user information of the first device and the second user information of the second device, and provide interface data corresponding to the provided contents to the second device if the second device is authenticated.

The interface data may be updated by the second device, and the interface data provider may update the interface data based on update information from the second device.

The first user information of the first device and the second user information of the second device include subscriber information containing authority to use the plurality of contents, and contents user information corresponding to the requested contents.

The interface data provider authenticates the second device by using the subscriber information.

The requested contents may be game contents, and the content using information may include avatar information related to the game contents. The interface may be displayed on a screen of the second device based on the provided interface data.

According to an aspect of another exemplary embodiment, a method for providing an interface customized to contents among a plurality of contents is provided. The method may include receiving, from a first device, first user information of the first device and a content request signal that requests the contents among the plurality of contents, providing the requested contents to the first device based on the received first user information of the first device, receiving, from a second device, second user information of the second device and an interface request signal that requests interface data, authenticating the second device by using the first user information of the first device and the second user information of the second device, and providing interface data corresponding to the provided contents to the second device if the second device is authenticated.

In the above-described method, the first user information of the first device and the second user information of the second device include subscriber information containing authority to use the plurality of contents, and contents user information corresponding to the requested contents.

If the interface data is updated by the second device, the interface data may be updated based on update information from the second device.

The second device may be authenticated using the subscriber information.

The requested contents may be game contents, and the content user information may include avatar information related to game contents. An interface may be displayed on a screen of the second device based on the provided interface data. The first user information may be the same as the second user information.

In accordance with yet another exemplary embodiment there is provided an apparatus for providing an interface customized to contents among a plurality of contents. The apparatus comprises: a contents provider configured to receive first user information of the first device and a content request signal that requests the contents among the plurality of contents, and provide the requested contents to the first device based on the received first user information of the first device; an interface request receiver configured to receive second user information of the second device and an interface request signal that requests interface data; and an interface data provider configured to authenticate the second device by using the first user information of the first device and the second user information of the second device, and provide interface data corresponding to the provided contents to the second device if the second device is authenticated.

In another exemplary embodiment, there is provided a method for providing an interface customized to contents among a plurality of contents. The method comprising: receiving first user information of the first device and a content request signal that requests the contents among the plurality of contents; providing the requested contents to the first device based on the received first user information of the first device; receiving second user information of the second device and an interface request signal that requests interface data; authenticating the second device by using the first user information of the first device and the second user information of the second device; and providing interface data corresponding to the provided contents to the second device if the second device is authenticated.

In accordance with the exemplary embodiment, by automatically providing interfaces optimized for each of various types of contents by using the user device without requiring an additional selection procedure, the user can control the contents simply and conveniently.

According to the above-described aspects of the exemplary embodiments, when a multiple number of users use the contents together, they can control and use the contents with their own user devices. Thus, without having to purchase additional remote controllers, the users can use the contents simultaneously.

According to the above-described aspects of the exemplary embodiments, by providing a function for allowing a user to share interface data that they have created by themselves, various types of interface data can be obtained for the same contents. Thus, it is possible to provide services more optimally customized to users' needs.

### BRIEF DESCRIPTION OF THE DRAWINGS

Non-limiting and non-exhaustive exemplary embodiments will be described in conjunction with the accompanying drawings. Understanding that these drawings depict only several exemplary embodiments in accordance with the disclosure and are, therefore, not intended to limit its scope, the disclosure will be described with specificity and detail through use of the accompanying drawings, in which:

FIG. 1 is a diagram illustrating an entire system for providing an interface customized to contents in accordance with an exemplary embodiment;

FIG. 2 is a detailed diagram illustrating an apparatus for providing an interface customized to contents in accordance with an exemplary embodiment;

FIGS. 3 (A and B) to 9 are diagrams for illustrating examples of providing interfaces suited to contents information to a user device; and

FIG. 10 is a flowchart for describing a method for providing an interface customized to contents in accordance with another exemplary embodiment.

### DETAILED DESCRIPTION OF EXEMPLARY EMBODIMENTS

Hereinafter, exemplary embodiments will be described in detail with reference to the accompanying drawings so that the present inventive concept may be readily implemented by those skilled in the art. However, it is to be noted that the present disclosure is not limited to the exemplary embodiments, but can be realized in various other ways. In the drawings, certain parts not directly relevant to the description are omitted to enhance the clarity of the drawings, and like reference numerals denote like parts throughout the whole document.

Throughout the whole document, the terms “connected to” or “coupled to” are used to designate a connection or coupling of one element to another element, and include both a case where an element is “directly connected or coupled to” another element and a case where an element is “electronically connected or coupled to” another element via still another element. Further, each of the terms “comprises,” “includes,” “comprising,” and “including,” as used in the present disclosure, is defined such that one or more other components, steps, operations, and/or the existence or addition of elements are not excluded in addition to the described components, steps, operations and/or elements.

Hereinafter, exemplary embodiments will be explained in detail with reference to the accompanying drawings.

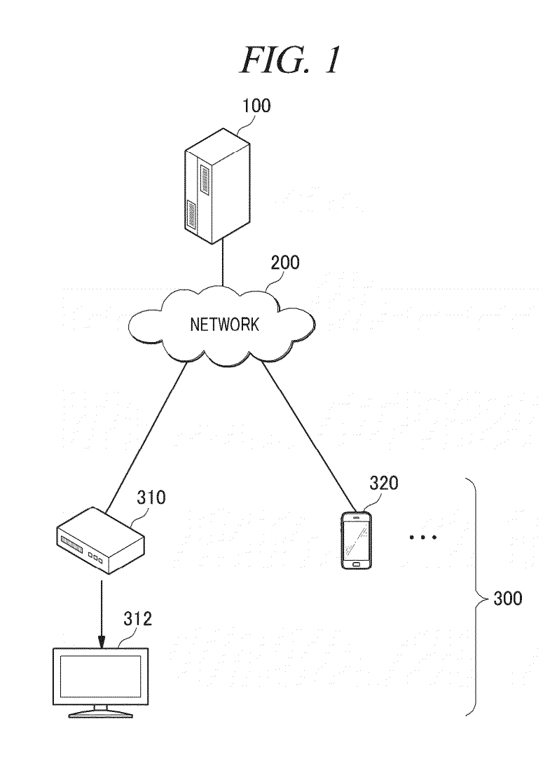

FIG. 1 is a diagram illustrating an entire system for providing an interface customized to contents (hereinafter, referred to as a “contents-customized interface”) in accordance with an exemplary embodiment

As shown in FIG. 1, the contents-customized interface providing system includes a contents-customized interface providing apparatus 100, a network 200 and a multiple number of user devices 300.

Hereinafter, for the convenience of explanation of the contents-customized interface providing system, there will be described an example case of providing a contents-customized interface for an IPTV service. In the description, an IPTV set top box is described as a first device 310 and a user device is referred to as a second device 320. However, this configuration is nothing more than an example, and the exemplary embodiment is not limited thereto.

Here, a device of the IPTV set top box may be implemented by one of a TV having a built-in IPTV set top box (IPTV STB) in the form of hardware or software, an IPTV set top box connected to a user's TV, a computer, a notebook computer or a personal mobile device. The IPTV set top box serves to convert an IPTV service provided from an IPTV service system through an information communication network into a form capable of being watched in TV and provide the converted form of IPTV service to TV. Further, the IPTV set top box also has a function of processing a control signal inputted through an IPTV remote controller. In addition, the IPTV set top box may also have a function of authenticating a user to determine whether the user is capable of using an interface customized to IPTV contents and a function of providing IPTV interface data requested by the user.

The TV (312) shows an image provided by the IPTV set top box to the user and may function as an interface for showing an IPTV service menu to the user and helping the user select the IPTV service menu.

The network 200 may be implemented by a wired network such as a local area network (LAN), a wide area network (WAN) or a value added network (VAN), a wireless networks such as a mobile radio communication network or a satellite communication network.

The multiple numbers of user devices 300 include the first device 310 and the second device 320.

Each of the user devices 300 may be implemented by a computer or a mobile device capable of accessing a remote server through a network. Here, the computer may include, but is not limited to, a notebook computer equipped with a web browser, a desktop computer, a laptop computer, etc. The mobile device may include, as a portable and mobile radio communication device, all kinds of handheld radio communication devices such as Personal Communication System (PCS), Global System for Mobile communications (GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), Wireless Broadband Internet (Wibro) devices, a smart phone, a tablet and a pad.

The second device 320 may include a wireless device, such as, but not limited to, a mobile phone, a smart phone, a PDA, a tablet, a notebook computer, a wireless internet device or a home robot, which has a touch screen capable of changing scenes and is capable of controlling an IPTV service by directly sending a control signal to the IPTV set top box wirelessly or sending a control signal to the IPTV set top box through a wireless network. The second device may also include various kinds of wireless devices capable of controlling an IPTV service by accessing a network. Further, the second device may also include a wired device such as, but not limited to, an internet phone or a PC, which has a touch screen and is capable of changing scenes. By way of example, the second device 320 may include a device connected to the IPTV set top box by a wired line directly or a device connected to the IPTV set top box by a wired line through a network.

The contents-customized interface providing system is configured to transmit various IPTV services provided from a contents provider, a program supplier, a data supplier or a ground wave supplier to the IPTV set top box through a network, authenticate a user for whether the user is authorized to use the IPTV service and the contents-customized interface and provide the interface data requested by the user.

If a user executes a contents-customized interface module of a user device, the user device provides the contents-customized interface providing apparatus 100 with user information included in the user device, such as an IPTV user ID or a phone number, and is authorized to use a contents-customized interface. Here, the user information may include subscriber information including authority for using various kinds of contents and contents user information for the contents.

If the authentication of the user device is completed using the subscriber information, the user device can be provided with information of contents being used in the first device from the contents-customized interface providing apparatus 100. Then, the user device searches for interface data corresponding to the contents information.

By way of example, based on the provided contents information, the user device determines the kind of IPTV service being used in a TV, and confirms whether there is IPTV service interface data corresponding to the determined kind of IPTV service in the user device.

If the interface data corresponding to the contents information is found in the user device, the user device automatically executes a remote controller for the IPTV service and displays the data on a screen of the user device.

Meanwhile, if no interface data corresponding to the contents information is found in the user device, the user device automatically requests a download of interface data to the contents-customized interface providing apparatus 100 or the IPTV set top box. Then, the user device downloads and stores the interface data, executes an interface for the IPTV service and displays the data on the screen of the user device.

The user is capable of creating interface data in a desired form, or generating new interface data by editing existing interface data. The interface data generated by the user is not only stored in the contents-customized interface providing apparatus 100 or the IPTV set top box but can also be shared by other users.

As stated above, the user device automatically provides user interfaces optimized for each of the various services provided by the IPTV without requiring an additional selection procedure, thus allowing the user to use the IPTV services easily and conveniently.

Moreover, when a multiple number of users want to use an IPTV service together, the users may connect their user devices to the IPTV set top box or the network. Then, by controlling the IPTV service through a user interface optimized for the IPTV service, the users can use the IPTV service simultaneously without needing to purchase additional IPTV remote controllers.

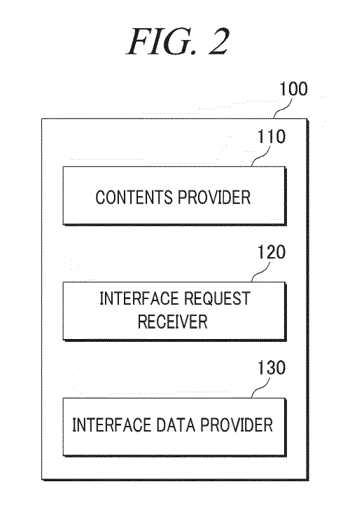

FIG. 2 is a detailed diagram illustrating an apparatus for providing an interface customized to contents in accordance with an exemplary embodiment.

The contents-customized interface providing apparatus 100 includes a contents provider 110, an interface request receiver 120 and an interface data provider 130.

The contents provider 110 receives, from a first device (not shown), user information and a contents request signal requesting any one kind of contents among various kind of contents. Then, based on the received user information, the contents provider 110 provides the requested contents to the first device. Here, the user information of the first device may include subscriber information including authority for using the various kinds of contents and contents user information for the contents. By way of example, in case of game contents, the contents user information may include avatar information of the game contents.

The interface request receiver 120 receives user information of the second device and an interface request signal that requests interface data from a second device (not shown). The user information of the second device may be the same as the user information of the first device.

The interface data provider 130 authenticates the second device based on both the user information of the first device and the user information of the second device and provides the authenticated second device with interface data matched with the contents. For instance, the interface data provider 130 authenticates the second device if the user information of the first device is the same as the user information of the second device, and provides the authenticated second device with interface data corresponding to the contents provided to the first device.

The interface data provider 130 may authenticate the second device by determining whether the second device is authorized to use the contents by using the subscriber information included in the user information, and provide the authenticated second device with the contents and the interface data matched with the contents user information.

Based on the interface data provided to the second device, an interface matched with the contents may be displayed on a screen of the second device.

Meanwhile, when interface data is updated by the second device and update information is received from the second device, the interface provider data 130 may update the interface data based on the update information.

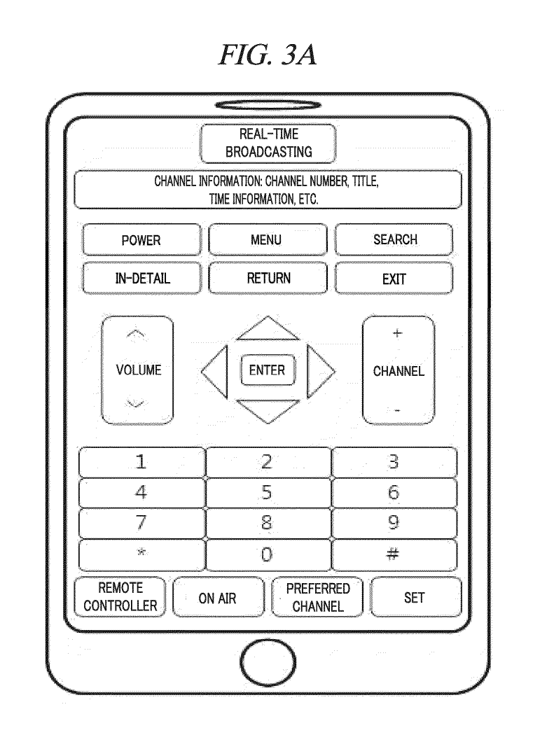

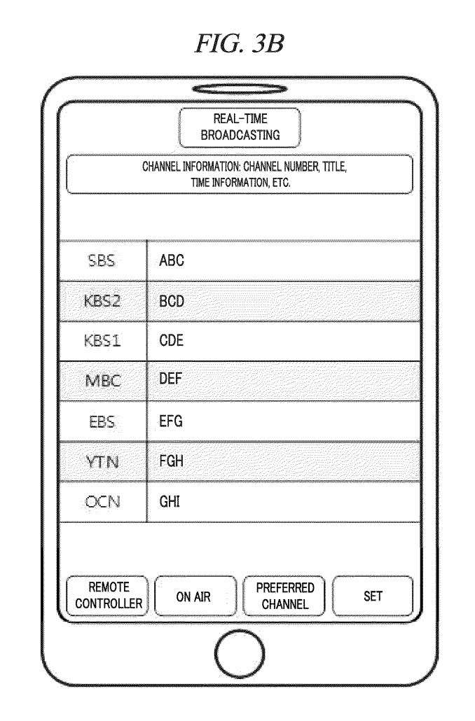

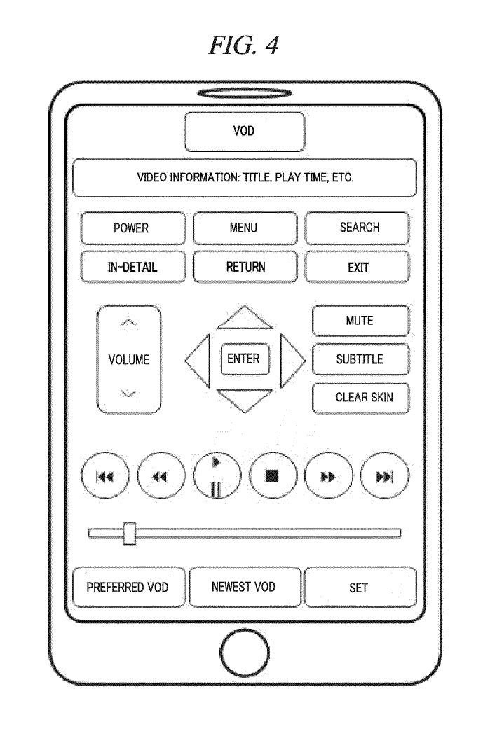

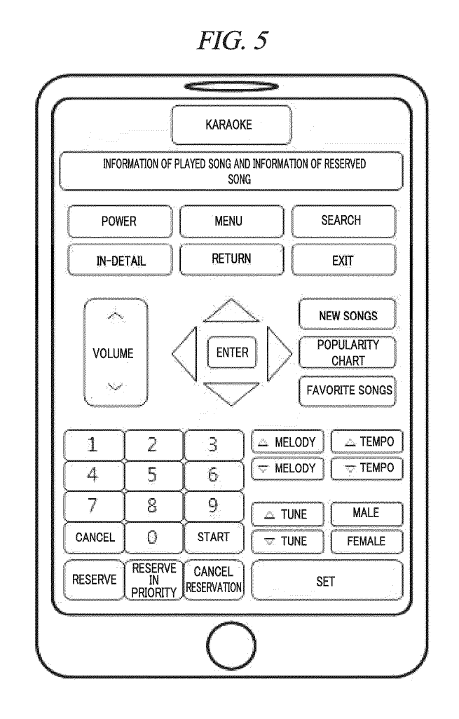

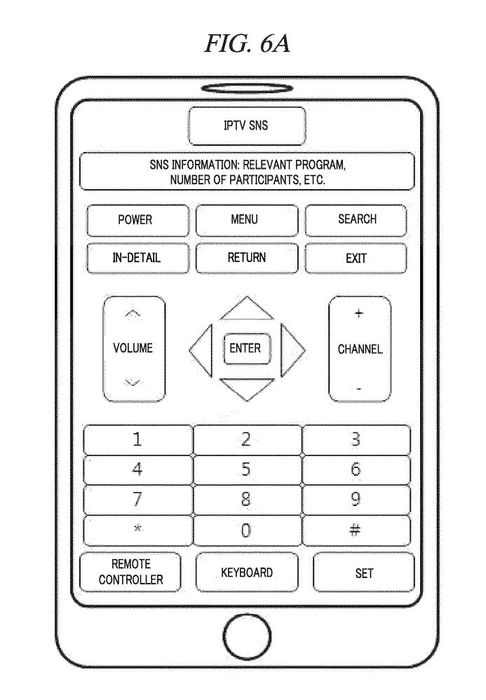

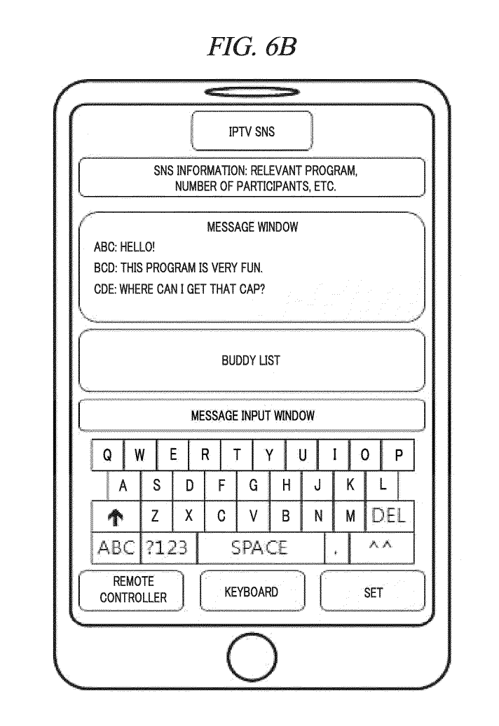

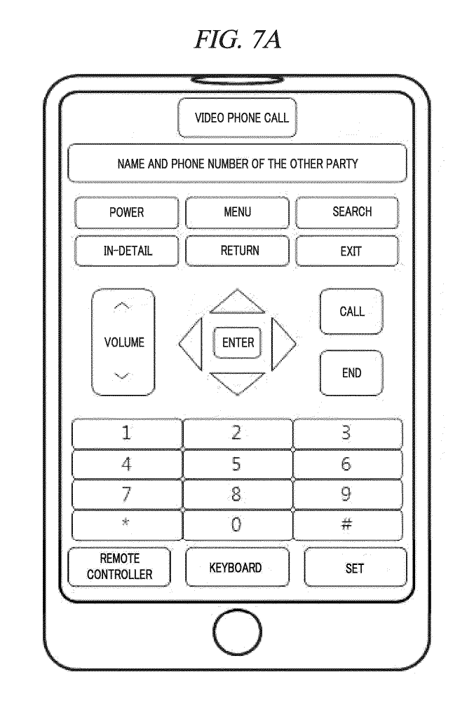

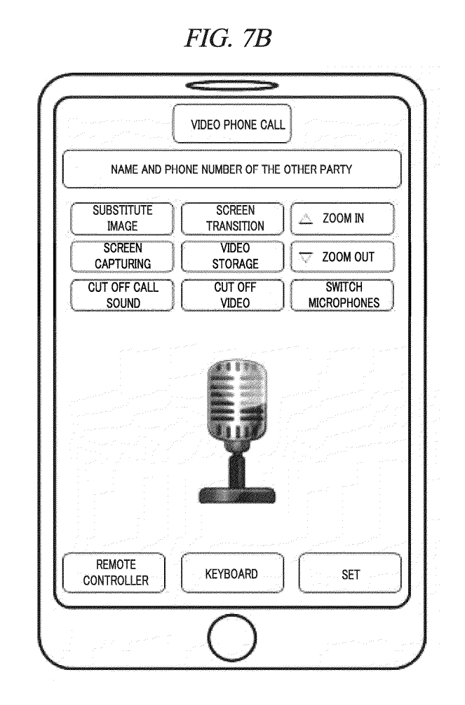

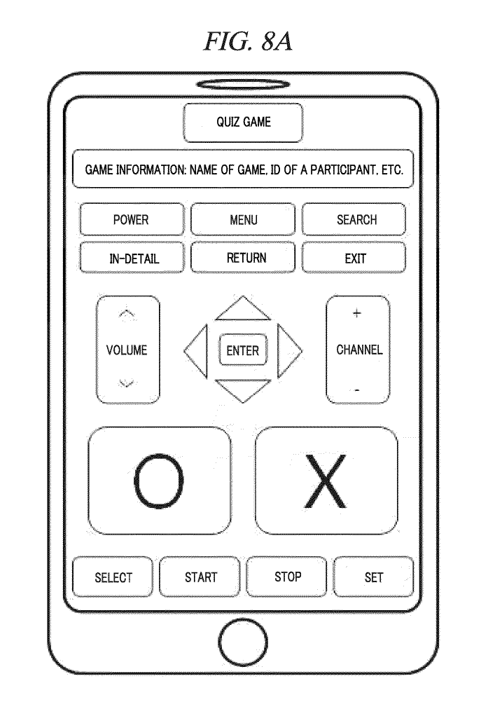

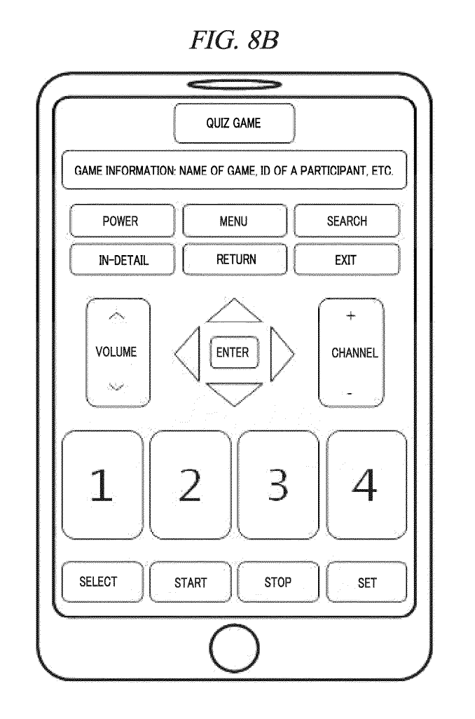

FIGS. 3 (A and B) to 9 are diagrams for illustrating examples of providing interfaces suited to contents information to a user device.

FIGS. 3A and 3B show an image of a user interface of a remote controller using a user device, customized to a real-time broadcasting service among various types of IPTV services in accordance with an exemplary embodiment.

As depicted in FIG. 3A, since the IPTV real-time broadcasting service is similar to watching TV, it may be desirable that the remote controller of the user device therefor is similar to a remote controller of TV. That is, the user interface of the remote controller for the IPTV real-time service includes a volume control button, a channel selecting button and number keypad buttons through which a user can directly input a desired channel number to directly move to a channel that they want to watch.

Further, the user interface of the remote controller for IPTV real-time broadcasting service may be configured to display, at a top portion thereof, the kind of the IPTV service and information of the channel that the user is currently watching, such as a channel number, a title of a program being broadcasted on a real time basis, a total broadcasting time and an elapsed time up to the current point in time, thus improving user convenience. Further, the user interface may additionally include a power button for controlling a power supply of the IPTV set top box, and a menu button, a search button, an in-detail button, a return button , an exit button, direction buttons and an enter button for helping the user check and select IPTV menus.

Furthermore, a user interface through which the user can directly check the channel information that the user is currently watching and can request a certain broadcasting program by clicking the desired broadcasting program may also be included. That is, if an ON AIR button at the bottom of the user interface shown in FIG. 3A is clicked, titles of broadcasting programs are provided together with broadcasting station information or channel numbers that are currently providing the broadcasting programs. If the user clicks a desired broadcasting program, the channel that the user is currently watching is switched to the selected channel. If the user wants to return back to the user interface in the form of the remote controller, the user only needs to select a remote controller menu as shown at the bottom of FIG. 3B.

Additionally, the user interface may further include a preferred channel menu for extracting and displaying information of only the channels preferred by the user during a real-time broadcasting time; and a configuration setting menu for allowing the user to modify menus exposed on the user interface in a desired way. The preferred channel menu may have a user interface similar to that shown in FIG. 3B. The preferred channel menu does not display all the broadcasting programs that are being currently broadcasted but serves to selectively show information of only the broadcasting programs of preferred channels registered by the user or broadcasting programs frequently watched by the user.

FIG. 4 illustrates an image of a user interface of a remote controller using a user device, customized to VoD among various types of IPTV services in accordance with an exemplary embodiment.

As depicted in FIG. 4, since the IPTV VoD broadcasting service is similar to watching video in that the user can watch it from any desired part at any desired time, it may be desirable that the form of the remote controller of the user device therefor may be similar to that of a video remote controller. That is, the IPTV VoD remote controller using the user device may provide a user interface including a return button, a rewind button, a play/pause button, a stop button, a fast forward button, a next button, a volume control button, and a mute button. Further, the IPTV VoD remote controller using the user device may additionally include a function of displaying a current play time among the total play time in the form of a bar and a function of, if the user moves the bar to a part from which the user wants to watch, playing the VoD from that part.

Moreover, the IPTV VoD remote controller using the user device may be configured to display, at a top portion of the user interface, the type of the IPTV service and information of a VoD program that the user is currently watching, such as a title and a total play time of the VoD program, thus improving user convenience. Further, the IPTV VoD remote controller may additionally include a subtitle button for allowing the user to turn on/off a subtitle function and select subtitles in various languages and a clear skin button for checking clear skin information provided by the VoD. In addition, the IPTV VoD remote controller using the user device may further include a power button for controlling a power supply of the IPTV set top box, a menu button, a search button, an in-detail button, a return button, an exit button, direction buttons and an enter button for helping the user check and select IPTV menus.

Additionally, the IPTV VoD remote controller using the user device may further include a preferred VoD menu for extracting and displaying information of only the VoD programs preferred by the user among VoD broadcasting programs and a newest VoD menu for showing newly registered VoD programs. Further, the IPTV remote controller may also include a configuration setting menu for allowing the user to modify menus exposed on the user interface in a desired way.

FIG. 5 shows an image of a user interface of a remote controller using a user device, customized to a karaoke service among various IPTV services in accordance with an exemplary embodiment.

As depicted in FIG. 5, the IPTV karaoke service is a service for, if a user selects a song, playing a melody for the song and showing lyrics through IPTV. Accordingly, it is desirable that the remote controller for this karaoke service is similar to a remote controller used in a karaoke. That is, the IPTV karaoke service remote controller using a user device may include number keypad buttons for selecting a song, a start button for starting the selected song, a cancel button for canceling the selected song, a reservation button for reserving selected songs in order, a priority reservation button for reserving a selected song, a reservation cancel button for canceling a selected song, a melody control button for controlling the kind of melody, a tempo control button for controlling a tempo, a tuning button for tuning, a male/female button for switching between a male tune an a female tune, a volume control button for controlling a volume, a newest song button for showing the newest songs, a popular chart button for showing popular songs selectively, a favorite song button for extracting and showing only the songs that the user sings frequently.

Further, the IPTV karaoke service remote controller using the user device may be configured to display, at a top of the user interface, the type of the IPTV service and information of a song, such as a title of the song that is being currently played and titles of reserved songs, thus improving user convenience. In addition, the IPTV karaoke remote controller using the user device may further include a power button for controlling a power supply of the IPTV set top box, and a menu button, a search button, an in-detail button, a return button, an exit button, direction buttons and an enter button for helping the user check and select IPTV menus. Further, the IPTV karaoke remote controller using the user device may additionally include a configuration setting menu for allowing the user to modify menus exposed on the user interface in a desired way.

FIGS. 6A and 6B are images of a user interface of a remote controller using a user device, customized to SNS among various types of IPTV services in accordance with an exemplary embodiment.

SNS provided by IPTV is operated in the manner that users who share interests upload and read their messages while using an IPTV service. Accordingly, for the SNS, a TV remote controller interface familiar to the users and a keyboard interface for allowing the users to perform SNS inputs conveniently are provided so as to be switchable therebetween. That is, as illustrated in FIG. 6A, the IPTV SNS service remote controller using a user device may provide a function of a remote controller for allowing a user to select a channel for a desired broadcasting program and use SNS. To this end, the user interface may have a volume control button, a channel selecting button, and number keypad buttons for enabling the user to directly input channel numbers to move to a desired channel directly.

Further, the IPTV SNS remote controller using the user device may be configured to display, at a top portion of the user interface, the type of the IPTV service and SNS information, such as a relevant broadcasting program and the number of SNS participants, thus improving user convenience. In addition, the IPTV SNS remote controller using the user device may further include a power button for controlling a power supply of the IPTV set top box, and a menu button, a search button, an in-detail button, a return button, an exit button, direction buttons and an enter button for helping the user check and select IPTV menus. That is, if a keyboard button at the bottom of the user interface shown in FIG. 6A is clicked, a message window for checking messages uploaded through SNS, a buddy list for checking presence of registered friends and a keyboard interface for allowing the user to input a SNS message are provided. If the user wants to return to the user interface in the form of the remote controller, the user only needs to select a remote controller menu shown in the bottom of FIG. 6B.

In addition, the IPTV SNS remote controller using the user device may further include a configuration setting menu for allowing the user to modify menus exposed on the user interface in a desired way. Depending on setting by the user or the service provider's policy for providing the IPTV remote controller, only the keyboard interface as shown in FIG. 6B may be provided without adopting the scheme in which the remote controller interface and the keyboard interface are switchable.

FIGS. 7A and 7B illustrate an image of a user interface of a remote controller using a user device, customized to a video phone call among various types of IPTV services in accordance with an exemplary embodiment.

As depicted in FIG. 7A, for a video phone call service, a process for making a call is required. Accordingly, it is desirable that the form of the user interface of the user device is similar to a keypad of a phone. That is, the user interface of the remote controller for the IPTV video phone call has key pad buttons for inputting phone numbers, a call button, an end button and a volume control button. Further, the IPTV video phone call remote controller may be configured to display, at a top portion of the user interface, the type of the IPTV service and the name and the phone number of the other party that the user is talking to, thus improving user convenience. Further, the IPTV video phone call remote controller additionally includes a power button for controlling a power supply of the IPTV set top box, and a menu button, a search button, an in-detail button, a return button, an exit button, direction buttons and an enter button for helping the user check and select IPTV menus.

In case of a video phone call using IPTV, since a microphone is located away from the user, noises may be generated. To resolve this problem, there may be provided a service for delivering sounds by using a user device having a built-in microphone.

After connected to the other party through the IPTV video phone call service, if a call menu button at the end of the user interface shown in FIG. 7A is clicked, the current interface is changed to a user interface capable of executing commands related to a video phone call. A microphone state is displayed to deliver sounds using the user device, and there are also displayed a substitute image button for sending a substitute image for protection of an individual private life, a screen transition button for changing a size and a position of an image, a screen capturing button for storing a freeze frame of a scene of a video phone call, a video storage button for storing the content of the video phone call, an image zoom-in button for scaling up an image, an image zoom-out button for scaling down an image, a call cutting-off button for cutting off transmission of call sounds or video, and a microphone switchover button for switching a microphone connected to the IPTV set top box and a microphone of the user device. When the user wants to return to the user interface in the form of the key pad, the user only needs to select a keypad menu shown at the bottom of FIG. 7B.

In addition, the IPTV SNS remote controller using the user device may further include a configuration setting menu for allowing the user to modify menus exposed on the user interface in a desired way.

FIG. 8 illustrates an image of a user interface using a user device, customized to a quiz game among various types of IPTV services.

As shown in FIGS. 8A and 8B, the user interface may be changed depending on the type of quiz game. That is, if the answer of the quiz game has a choice of O or X, an O button and an X button are displayed, as shown in FIG. 8A. If the answer of the quiz game has four choices from 1 to 4, numerals 1 to 4 are displayed as shown in FIG. 8B. This user interface with answer choices can be provided in various ways depending on the type of the quiz game. Further, the user interface of the remote controller customized to the quiz game may include a selecting button for selecting a choice of the answer for the game, a start button for starting the game and a stop button for stopping the game. Further, the type of the IPTV service and game information such as the title of the game and an ID of a participant may be displayed at a top portion of the user interface, so that user convenience can be improved. Furthermore, the user interface of the remote controller for the quiz game may also include a power button for controlling a power supply of the IPTV set top box, and a menu button, a search button, an in-detail button, a return button, an exit buttons, direction buttons and an enter button for helping the user check and select IPTV menus. In addition, the user interface of the remote controller for the quiz game may also have a configuration setting menu for allowing the user to modify menus exposed on the user interface in a desired way.

FIGS. 9A to 9B illustrate images of a user interface of a remote controller using a user device, customized to a battle game among various IPTV services.

In case of a battle game, it is desirable to provide a joystick interface on the entire screen of a user device. Thus, a basic remote controller interface for selecting IPTV menus and a joystick interface for the battle game may be provided so as to be switched therebetween.

That is, as illustrated in FIG. 9A, the basic remote controller user interface for selecting IPTV menus provide a power button for controlling a power supply of the IPTV set top box, a menu button, a search button, an in-detail button, a return button, an exit button, direction buttons and an enter button for helping the user check and select the IPTV menus. Further, a volume control button, a channel selecting button and number keypad buttons for inputting numerals may be additionally included. Further, the type of the IPTV service and game information such as the title of the game and an ID of a participant may be displayed at a top portion of the user interface, so that user convenience can be improved.

In order to switch to the joystick interface for the battle game, if a joystick button at the bottom of the user interface as shown in FIG. 9A is clicked, direction buttons and Δ, □, ×, ◯ buttons for making movements are displayed, as illustrated in FIG. 9B. Further, the user interface of the remote controller customized to the battle game using the user device may also include a selecting button for selecting a character or a game, a start button for starting the game, and a stop button for stopping the game. If the user wants to return to the user interface in the form of the remote controller, the user only needs to select a remote controller menu shown in FIG. 9B. In addition, there may also be provided a configuration setting menu for allowing the user to modify menus exposed on the user interface of the IPTV battle game remote controller in a desired way.

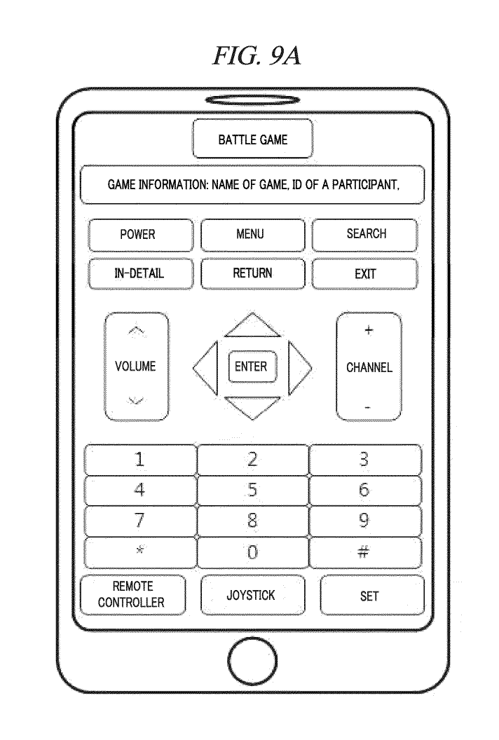

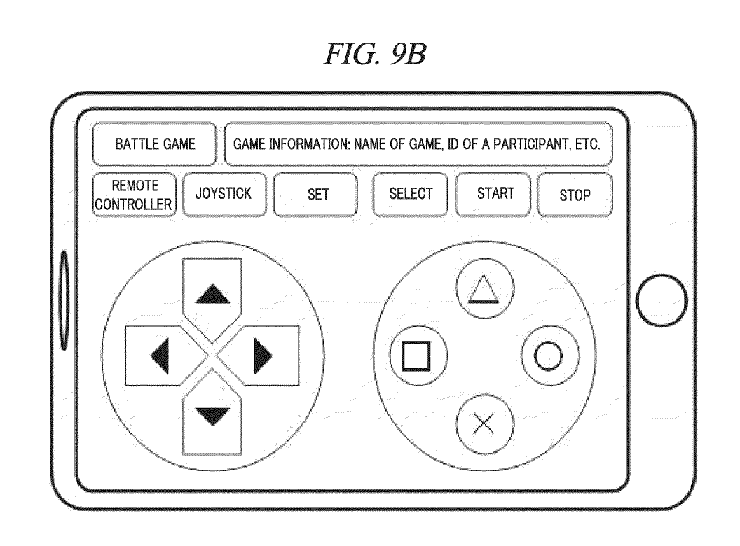

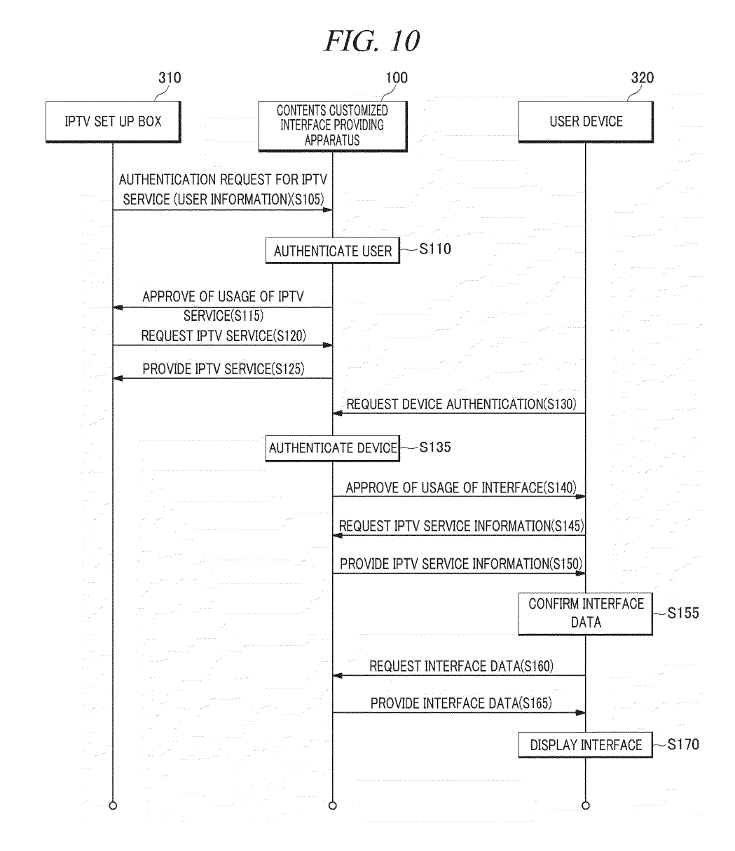

FIG. 10 is a flowchart for describing a method for providing an interface customized to contents in accordance with another exemplary embodiment.

As depicted in FIG. 10, the IPTV set top box provides the contents-customized interface providing apparatus 100 with user information, and requests authentication of a user for an IPTV service (S105).

The contents-customized interface providing apparatus 100 confirms the received user information and authenticates the user for the IPTV service (S110). Then, the content-customized interface providing apparatus 100 approves of the IPTV set top box using the IPTV service (S115).

The IPTV set top box requests an IPTV service to the content-customized interface providing apparatus 100 (S120), and the content-customized interface providing apparatus 100 and provides the IPTV set top box with the requested IPTV service (S125).

If the user executes a content-customized interface module in a user device in order to use a content-customized interface through the use of the user device, the user device transmits user information and an interface request signal requesting interface data to the content-customized interface providing apparatus 100, and requests authentication of the user device for the usage of the content-customized interface (S130). Here, the user information may include subscriber information including authority for using various kinds of contents and contents user information for contents.

The content-customized interface providing apparatus 100 authenticates the user device based on the subscriber information (S135) and approves of the user device for the usage of the interface (S140).

The user device that has gained approval for the usage of the interface sends the content-customized interface providing apparatus 100 a request for information of an IPTV service that a user is currently using in order to check the type of the IPTV (S145).

The content-customized interface providing apparatus 100 investigates the type of the IPTV service that the user is currently using and provides the user device with the IPTV service information (S150).

The user device that has received the IPTV service information from the content-customized interface providing apparatus 100 determines whether there exists interface data corresponding to the received IPTV service information in the user device (S155).

If the interface data is not found in the user device, the user device makes a request to download the interface data for the corresponding IPTV service to the content-customized interface providing apparatus 100 (S160), and downloads the interface data from the content-customized interface providing apparatus 100 and stores the downloaded interface data (S165).

Thereafter, the user device displays a user interface based on the user interface data (S170).

Meanwhile, if the interface data is found in the user device, the user device omits the steps S160 and S165 and displays a user interface based on the interface data on a screen of the user device.

The flowchart of FIG. 10 for providing the interface customized to the type of the IPTV can be automatically performed once the user executes the content-customized interface module of the user device. Further, a wired or wireless network device may be further included to relay data between the IPTV set top box, the user device and the content-customized interface providing apparatus 100.

The exemplary embodiments may be embodied in a transitory or non-transitory storage medium which includes instruction codes which are executable by a computer or processor, such as a program module which is executable by the computer or processor. A data structure in accordance with the exemplary embodiments may be stored in the storage medium and executable by the computer or processor. A computer readable medium may be any usable medium which can be accessed by the computer and includes all volatile and/or non-volatile and removable and/or non-removable media. Further, the computer readable medium may include any or all computer storage and communication media. The computer storage medium may include any or all volatile/non-volatile and removable/non-removable media embodied by a certain method or technology for storing information such as, for example, computer readable instruction code, a data structure, a program module, or other data. The communication medium may include the computer readable instruction code, the data structure, the program module, or other data of a modulated data signal such as a carrier wave, or other transmission mechanism, and includes information transmission mediums.

The above description of the exemplary embodiments is provided for the purpose of illustration, and it will be understood by those skilled in the art that various changes and modifications may be made without changing a technical conception and/or any essential features of the exemplary embodiments. Thus, the above-described exemplary embodiments are illustrative in all aspects, and do not limit the present disclosure. For example, each component described to be of a single type can be implemented in a distributed manner. Likewise, components described to be distributed can be implemented in a combined manner.

The scope of the present inventive concept is defined by the following claims and their equivalents rather than by the detailed description of the exemplary embodiments. It shall be understood that all modifications and embodiments conceived from the meaning and scope of the claims and their equivalents are included in the scope of the present inventive concept.

What is claimed is:

1. An apparatus for providing an interface customized to contents among a plurality of contents, the apparatus comprising:
a contents provider configured to receive, from a first device, first user information of the first device and a content request signal that requests the contents among the plurality of contents, and provide the requested contents to the first device based on the received first user information of the first device;
an interface request receiver configured to receive, from a second device, second user information of the second device and an interface request signal that requests interface data; and
an interface data provider configured to authenticate the second device by using the first user information of the first device and the second user information of the second device, and provide interface data corresponding to the provided contents to the second device if the second device is authenticated.

2. The apparatus of claim 1,
wherein if the interface data is updated by the second device, the interface data provider updates the interface data based on update information from the second device.

3. The apparatus of claim 1,
wherein the first user information of the first device and the second user information of the second device include subscriber information containing authority to use the plurality of contents, and contents user information corresponding to the requested contents.

4. The apparatus of claim 3,
wherein the interface data provider authenticates the second device by using the subscriber information.

5. The apparatus of claim 4,
wherein the requested contents are game contents, and the content user information includes avatar information related to the game contents.

6. The apparatus of claim 1, wherein an interface is displayed on a screen of the second device based on the provided interface data.

7. The apparatus of claim 1, wherein the first user information is the same as the second user information.

8. A method for providing an interface customized to contents among a plurality of contents, the method comprising:
receiving, from a first device, first user information of the first device and a content request signal that requests the contents among the plurality of contents;
providing the requested contents to the first device based on the received first user information of the first device;
receiving, from a second device, second user information of the second device and an interface request signal that requests interface data;
authenticating the second device by using the first user information of the first device and the second user information of the second device; and
providing interface data corresponding to the provided contents to the second device if the second device is authenticated.

9. The method of claim 8,
wherein the first user information of the first device and the second user information of the second device include subscriber information containing authority to use the plurality of contents, and contents user information corresponding to the requested contents.

10. The method of claim 8, wherein if the interface data is updated by the second device, the interface data is updated based on update information from the second device.

11. The method of claim 9, wherein the second device is authenticated using the subscriber information.

12. The method of claim 11, wherein the requested contents are game contents and the content user information includes avatar information related to game contents.

13. The method of claim 8, wherein an interface is displayed on a screen of the second device based on the provided interface data.

14. The method of claim 8, wherein the first user information is the same as the second user information.

15. An apparatus for providing an interface customized to contents among a plurality of contents, the apparatus comprising:
a contents provider configured to receive first user information of the first device and a content request signal that requests the contents among the plurality of contents, and provide the requested contents to the first device based on the received first user information of the first device;
an interface request receiver configured to receive second user information of the second device and an interface request signal that requests interface data; and
an interface data provider configured to authenticate the second device by using the first user information of the first device and the second user information of the second device, and provide interface data corresponding to the provided contents to the second device if the second device is authenticated.

16. The apparatus of claim 15, wherein an interface is displayed on a screen of the second device based on the provided interface data.

17. The apparatus of claim 15, wherein the first user information is the same as the second user information.

18. A method for providing an interface customized to contents among a plurality of contents, the method comprising:
receiving first user information of the first device and a content request signal that requests the contents among the plurality of contents;
providing the requested contents to the first device based on the received first user information of the first device;
receiving second user information of the second device and an interface request signal that requests interface data;
authenticating the second device by using the first user information of the first device and the second user information of the second device; and
providing interface data corresponding to the provided contents to the second device if the second device is authenticated.

19. The method of claim 18, wherein an interface is displayed on a screen of the second device based on the provided interface data.

20. The method of claim 18, wherein the first user information is the same as the second user information.
